(19) United States
(12) Patent Application Publication
(10) Pub. No.: US 2012/0220704 A1
(43) Pub. Date: Aug. 30, 2012

(54) Plastic formulation for fishing lures and a method for making the same

(76) Inventors: Shawn Straley, LaGrange, IN (US); Kim Straley, LaGrange, IN (US)

(21) Appl. No.: 12/932,535

(22) Filed: Feb. 28, 2011

(51) Int. Cl. C08K 5/1515

(52) U.S. Cl. 524/114

(57) ABSTRACT

A method of producing a phthalate-free liquid plastic formulation that is suitable for use as a fishing lure is disclosed. The method includes preparing a mixture containing from about 5 and 90 weight percent DINCH plasticizer; 5 and 90 weight percent dioctyl adipate plasticizer; 10 and 50 weight percent homopolymer vinyl dispersion resin; 0.5 and 20 weight percent paste making vinyl chloride homopolymer produced by the Pevikon process; 1 and 30 weight percent of epoxidized soybean oil; 0.5 and 10 weight percent PVC heat stabilizer; and an amount of silicone which is sufficient to prevent the mixture from foaming. The mixture is heated. The mixture is mixed until it has a uniform consistency, to thereby produce the desired liquid plastic formulation.

### I. TECHNICAL FIELD OF THE INVENTION

The present invention relates to a generally liquid, plastic formulation and method of making the formulation which among other things substitutes di(isononyl)Cyclohexane-1,2-dicarboxylate, also known as DINCH, for phthalate plasticizers. The formulation is ideally suited for use in fishing lures.

### II. BACKGROUND OF INVENTION

According to the US Fish and Wildlife Service, fishing is one of the most common outdoor recreational activities in the U.S. with over 40 million participants of all ages and demographics. In order to catch fish, one must use some sort of inducement to attract the fish to the hook. These inducements typically comprise either some sort of natural, food-like bait (e.g. worms, squids, minnows, insects, etc.), or an artificial lure.

One of the most common types of fishing lure used is the soft plastic-style lures that are designed to look like worms, crayfish, and other tantalizing fish treats. Approximately 20 million pounds of these soft plastic lures are cast into US streams, lakes and rivers every year. Most of these are lost or discarded in or near the same lakes, rivers and streams.

Since at least the 1950's, one of the most common forms of plastic used in the production of soft plastic fishing lures has been a mixture of PVC, phthalates, and stabilizers. The phthalates are added to the PVC/stabilizer mix to act as a softener to the plastic Unfortunately the phthalates do not actually chemically bind with the PVC, and they tend to leach out over time. This leaching effect combined with the high concentration of phthlates used in the lures leads to approximately 10 million pounds of phthlates being directly deposited into the US water supply every year.

The EPA lists phthalates as a hazardous substance. They are considered reproductive toxins and have been linked to asthma in children, breast cancer, and a number of reproductive related health problems. At least three states have banned phthalates in children's products, and others are considering similar legislation. Many retailers and mass marketing companies are working on phasing out phthalates in packaging materials. Nonetheless, phthalates remain a staple ingredient used in plastic fishing lures. See (http://www.alabamarivers.org/River%20Resources/ten-facts-about-fishing-lures-and-water-quality)

Accordingly, it would be desireable if phthalate-free plastic lures were available. Such phthalate free plastic lures would preferably not have a plastic or any other taste or scent which is undesirable to fish. Rather, the lures should have a taste or scent which actually attracts fish.

### III. SUMMARY OF THE INVENTION

In accordance with the present invention, a method is disclosed for preparing a plastic formulation for use in a fishing lure. The method comprises preparing a mixture containing from about 5 to 90 weight percent di(isononyl) cyclohexane-1,2-dicarboxylate (DINCH) plasticizer; 5 to 790 weight percent DOA plasticizer; 10 to 20 weight percent homopolymer vinyl dispersion resin; 0.5 to 20 weight percent paste making vinyl chloride homopolymer produced by the Pevikon process; 1 to 30 weight percent of epoxidized soybean oil; 0.5 to 10 weight percent PVC heat stabilizer; and an amount of silicone which is sufficeint to prevent the mixture from foaming. The mixture is heated and mixed until it has a generally uniform consistency, to thereby produce the desired liquid plastic formulation.

The present invention provides a phthalate-free, fish attracting liquid plastic formulation of the type similar to vinyl plastisol. Vinyl plastisol is a plastic used by fisherman who like to make their own soft plastic lures in shapes such as worms, insect-like shapes and other assorted shapes. The liquid is typically heated to about 325 degrees and then poured or injected into a mold having the shape, i.e. worm, insect, etc., that is desired by the fisherman. As the liquid cools in the mold it solidifies into a generally soft flexible plastic that simulates the look and feel of a real worm, insect, or other naturally occurring fish food. Salt, different colors, and glitter may also be added by the fisherman to the liquid in order for the fisherman to customize the lure as desired.

The present invention is based upon the surprising discovery that lures containing DINCH plasticizer actually attract fish. Chemically, DINCH is a di(isononyl) cyclohexane-1,2-dicarboxylate. DINCH was initially introduced into the formulation as an alternative for phthalates. Initially it was believed that lures not containing phthlates would have more of a plastic taste that would be rejected by fish. However, through experimenting with several different formulations it was discovered that DINCH containing lures not only attract fish, but cause the fish to hold onto the lure longer after biting.

In accordance with another aspect of the present invention, a dinch based soft plastic formulation comprises a liquid mixture of generally uniform consistency containing from about 10 to 80 weight percent DINCH plasticizer; 0 to 70 weight percent DOA plasticizer, 10 to 20 weight percent homopolymer vinyl dispersion resin; 0 to 10 weight percent paste-making vinyl chloride homopolymer produced by the Pevikon process; 0-10 weight percent of epoxidized soybean oil; 0.5 to 10 weight percent PVC heat stabilizer; and an amount of silicon which is sufficient to prevent the mixture from foaming.

In a more preferred embodiment of the present invention, the liquid mixture contains from about 40 to 77 weight percent DINCH plastizizer, 3 to 40 weight percent DOA plasticizer; 11 to 19 weight percent homopolymer vinyl dispersion resin; 0 to 5 weight percent paste-making vinyl chloride homopolymer produced by the Pevikon process; 1 to 8 weight percent of epoxidized soybean oil; 0.5 to 8 weight percent PVC heat stabilizer; and an amount of silicon that is sufficient to prevent the mixture from foaming.

In the most preferred embodiment of the invention known presently, the liquid mixture contains between about 67 to 72 weight percent DINCH plasticizer; between about 6 to 8 weight percent DOA plasticizer; between about 12 to 17 weight percent Geon 121 A PVC resin; between about 1 to 2 weight percent Pevikon P709 PVC resin; between about 2 to 6 weight percent of epoxidized soybean oil; and 0.8 to 5 weight percent heat stabilizer; and an amount of silicone which is sufficient to prevent the mixture from foaming.

These and other features and advantages of the present invention will become apparent to those skilled in the art upon a review of the drawings and description below which represent the best mode of practicing the invention perceived presently by the Applicants.

### IV. BRIEF DESCRIPTION OF DRAWINGS

FIG. 1 is a flow chart depicting the method used to properly mix the components of the plastic formula;

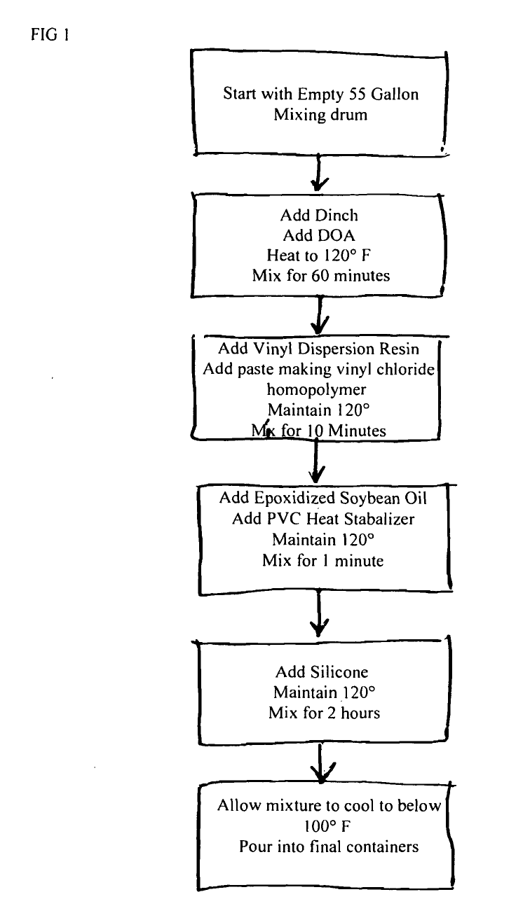

FIG. 2 is a flow chart depicting the method used to properly mix the components of the plastic formula as depicted in Example 1; and

FIG. 3 is a flow chart depicting the method used to properly mix the components of the plastic formula as depicted in Example 2.

### V. DETAILED DESCRIPTION

The preferred method of preparing a phthalate-free liquid formulation in accordance with the present invention is by placing the amounts set forth in more detail below of DINCH and DOA plasticizers in a mixing drum and heating the mixture to about 120° F. The mixing drum should be of the type that includes a mixing paddle that continuously mixes ingredients placed in the drum. After mixing and heating the plasticizers for about 60 minutes the aformentioned Geon 121A and the Pevicon P709 PVC resin are added to the mixture in the aforementioned amounts and this mixture is then mixed for another 10 minutes. The temperature of the mixture is maintained at about 120° F.

The Drapex 6.8 and Mark 1495C heat stabalizers are then added to the mixture and mixed for about 1 minute. The final ingredient, STK silicon, is then added in the above amount which acts as a defoaming agent to prevent the plastic from foaming. The final mixture is then mixed for about 2 hours and then allowed to cool to below 100° F. at which point the final mixture is typically poured into the containers in which the product is sold. These containers typically comprise pint containers, gallon containers, 5 gallon buckets, and/or 55 gallon drums.

The DINCH plasticizer used in the present invention comprises di(isononyl)cyclohexane-1,2-dicarboxylate and is available from the BASF Corporation of Florham Park, N.J. BASF's website address is www.basf.com. The DOA plasticizer used in the present invention is dioctyl addipate and is also available from the BASF Corporation of Florham Park, N.J. The Geon 121A PVC resin is a homopolymer vinyl dispersion resin and is available from Hydro Polymers of Sweden. Hydro Polymers website address is www.hydropolymers.com.

The Pevikon P70—PVC resin is a paste-making vinyl chloride homopolymer produced by the Pevikon process and is also available from Hydro Polymers of Sweden. The Drapex 6.8 is an epoxidized soybean oil and is available from Chemtura Corporation of Middlebury, Conn. Chemtura's website address is www.chemtura.com. The Mark 1495C heat stabilizer is also available from Chemtura. The STK pure silicon is Silicon 10,000 STK sold by the Dow Corning Corporation of Midland, Mich. Dow Corning's website address is www.dowcorning.com.

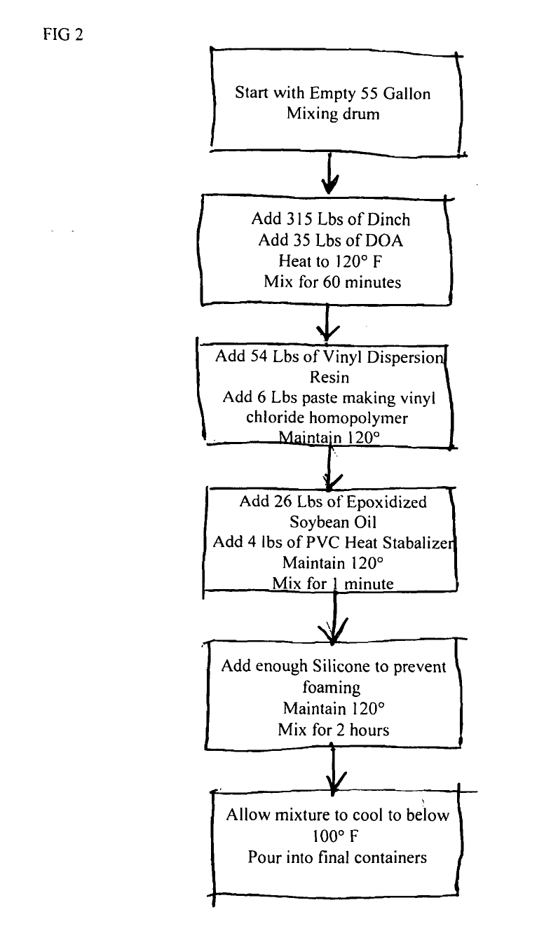

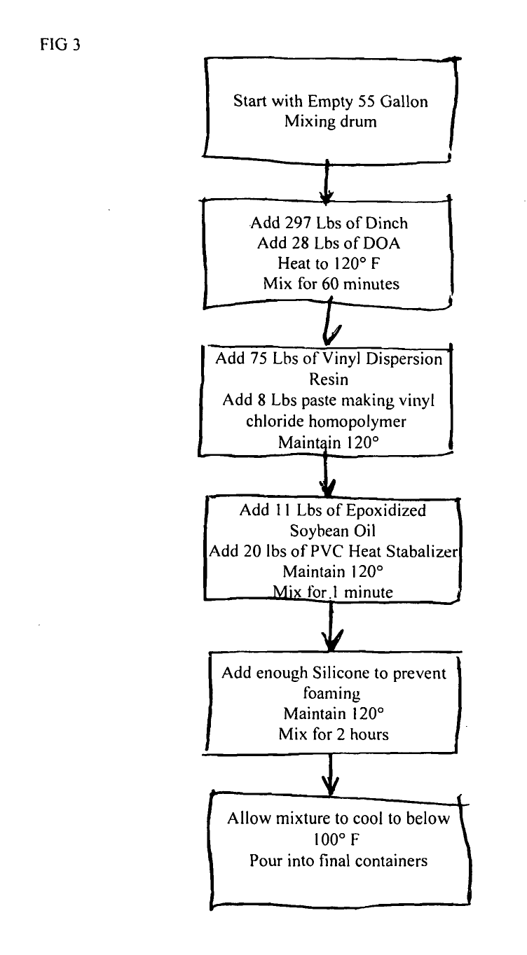

The invention will be better understood by reference to the following examples which are also illustrated in FIGS. 2 and 3.

### EXAMPLE 1

This example is presented to show a process for making a liquid formulation of the present invention which produces plastic lures having a soft feel.

| Ingredients | Weight in Pounds | Weight Percent |
|---|---|---|
| Dinch | 315 | 71.7 |
| Dioctyl Adipate | 35 | 7.9 |
| Geon 121A | 54 | 12.3 |
| Pevicon P709 | 6 | 1.3 |
| Drapex 6.8 Epoxidized Soy | 26 | 5.9 |
| Mark 1495C | 4 | 0.9 |

The amounts in pounds and weight percentages of the ingredients of the formulation producing the soft lures of this Example 1 are set forth in the immediately preceeding table.

The formulation is made by pouring the aforementioned plasticizers, i.e. 315 pounds of DINCH and 35 pounds of DOA into a heated 55 gallon mixing drum having a mixing paddle that continuously mixes the DINCH and DOA and which also heats the mixture to about 120° F. After mixing and heating the plasticizers for about 60 minutes, the aforementioned PVC resins, i.e. the Geon 121A and the Pevicon P709, are added to the mixture in the aforementioned amounts and the this mixture is mixed for another 10 minutes.

The temperature of the mixture is maintained at about 120° F. during the addition and mixing of the various components. The Drapex 6.8 and Mark 1495C heat stabilizers are added to the mixture and mixed for about 1 minute. The final ingredient, STK pure silicon, is added in the above amount which acts as a defoaming agent to prevent the plastic from foaming. The final mixture is then mixed for about 2 hours and then allowed to cool to below 100° F. at which point the final mixture is typically poured into the containers in which the product is sold. The mixture at this point is a liquid and has a consistency similar to milk.

As discussed above, to make a lure from this liquid, the liquid is heated to about 325° F., poured into a mold, and allowed to cool. This heating and cooling process causes the liquid formulation to solidify into a flexible plastic having the shape of the mold and the soft feel as discussed above.

### EXAMPLE 2

| Ingredients | Weight in Pounds | Weight Percent |
|---|---|---|
| DINCH | 297 | 67.9 |
| Dioctyl Adipate | 28 | 6.3 |
| Geon 121A | 75 | 17.0 |
| Pevicon P709 | 8 | 1.8 |
| Drapex 6.8 Epoxidized Soy | 11 | 2.5 |
| Mark 1495C | 20 | 4.5 |

The amounts in pounds and weight percentages of the ingredients of the formulation producing the soft lures of this example 2 are set forth in the immediately preeceding table.

The formulation is made by pouring the aforementioned plasticizers, i.e. 297 lbs of DINCH and 28 lbs of DOA into a heated 55 gallon mixing drum having a mixing paddle that continuously mixes the DINCH and DOA and which also heats the mixture to about 120° F. After mixing and heating the plasticizers for about 60 minutes, the aforementioned PVC resins, i.e. the Geon 121A and the Pevicon P709, are added to the mixture in the aforementioned amounts and then this mixture is mixed for another 10 minutes. The temperature of the mixture is maintained at about 120° F.

Then, the Drapex 6.8 and Mark 1495 heat stabilizer are added to the mixture and mixed for about 1 minute. The final ingredient, STK pure silicon, is added in the above amount which acts as a defoaming agent to prevent the plastic from foaming. The final mixture is then mixed for about 2 hours and then allowed to cool to below 100° F. at which point the final mixture is typically poured into the containers in which the product is sold. The mixture at this point is liquid and has a consistency similar to milk.

As discussed above, to make a lure from this liquid, the liquid is then heated to about 325° F. and poured into a mold and allowed to cool. This heating and cooling process causes the liquid formulation to solidify into a flexible plastic that assumes the shape of the mold and forms a lure having a somewhat hard, but resilient feel as discussed above.

### EXAMPLE 3

| Ingredients | Weight in Pounds | Weight Percent |
|---|---|---|
| DINCH | 305 | 69.4 |
| Dioctyl Adipate | 34 | 7.7 |
| Geon 121A | 63 | 14.3 |
| Pevicon P709 | 7 | 1.5 |
| Drapex 6.8 Epoxidized Soy | 25 | 5.6 |
| Mark 1495C | 5 | 1.1 |

The amounts in pounds and weight percentages of the ingredients of the formulation producing the soft lures of this example 2 are set forth in the immediately preeceding table.

The formulation is made by pouring the aforementioned plasticizers, i.e. 305 lbs of DINCH and 34 lbs of DOA into a heated 55 gallon mixing drum having a mixing paddle that continuously mixes the DINCH and DOA and which also heats the mixture to about 120° F. After mixing and heating the plasticizers for about 60 minutes, the aforementioned PVC resins, i.e. the Geon 121A and the Pevicon P709, are added to the mixture in the aforementioned amounts. This mixture is then mixed for another 10 minutes. The temperature of the mixture is maintained at about 120° F. Then, the Drapex 6.8 and Mark 1495 heat stabilizer are added to the mixture and mixed for about 1 minute. The final ingredient, STK pure silicon, is added in the above amount which acts as a defoaming agent to prevent the plastic from foaming.

The final mixture is then mixed for about 2 hours and then allowed to cool to below 100° F. at which point the final mixture is typically poured into the containers in which the product is sold. The mixture at this point is liquid and has a consistency similar to milk.

To make a lure from this liquid, the liquid is then heated to about 325° F. and poured into a mold and allowed to cool. This heating and cooling process causes the liquid formulation to solidify into a flexible plastic that assumes the shape of the mold and forms a lure having a somewhat hard, but resilient feel as discussed above.

As will be apparent to one skilled in the art, various modifications can be made within the scope of the aforesaid description. Such modifications being within the ability of one skilled in the art form a part of the present invention and are embraced by the appended claims.

1. A method of producing a phthalate-free liquid plastic fishing lure formulation comprising:
preparing a mixture containing from about 5 to 90 weight percent di(isononyl)Cyclohexane-1,2-dicarboxylate (DINCH) plasticizer; 5 to 90 weight percent dioctyl adipate plasticizer; 10 to 50 weight percent homopolymer vinyl dispersion resin; 0.5 to 20 weight percent vinyl chloride homopolymer produced by the Pevikon process capable of forming a paste; 1 to 30 weight percent of epoxidized soybean oil; 0.5 to 10 weight percent heat stabilizer for stabilizing the heat of a PVC Containing compound; and an amount of silicon which is sufficient to prevent the mixture from foaming;
heating the mixture; and
mixing the mixture until it has a uniform consistency, thereby producing the desired liquid plastic formulation.

2. A method as claimed in claim 1 wherein the step of heating the mixture comprises the step of heating the mixture to about 120° F.

3. A method as claimed in claim 1 further comprising the step of allowing the mixture to cool to about 100° F. after it has been mixed and has reached a uniform consistency.

4. A method as claimed in claim 1 wherein the step of heating the mixture includes the step of stirring the mixture while heating the mixture.

5. A method as claimed in claim 1 wherein the mixture is prepared and mixed in a mixing drum,
further comprising the step of pouring the desired liquid plastic formulation into containers.

6. A method as claimed in claim 1 wherein the homopolymer vinyl dispersion resin comprises Geon 121A.

7. A method as claimed in claim 1 wherein the epoxidized soybean oil comprises Drapex 6.8 epoxy plasticizer.

8. A method as claimed in claim 1 wherein the PVC heat stabilizer comprises a liquid calcium/zinc containing stabilizer.

9. A method as claimed in claim 1 wherein the liquid calcium/zinc containing heat stabilizer comprises Mark 1495C PVC stabilizer.

10. A method as claimed in claim 1 wherein the silicon comprises Silicon 10,000 STK.

11. A method as claimed in claim 1 wherein the mixture is mixed at about 120° for at least about 2 hours.

12. A method as in claim 1 wherein the mixture comprises between about 40 and 77 weight percent DINCH plasticizer; 3 and 40 weight percent dioctyl adipate plasticizer; 11 and 19 weight percent homopolymer vinyl dispersion resin; 0.5 and 5 weight percent vinyl chloride homopolymer produced by the Pevikon process; 1 and 8 weight percent of epoxidized soybean oil; 0.5 and 8 weight percent PVC heat stabilizer; and an amount of silicon which is sufficient to prevent the mixture from foaming.

13. A method as claim 1 wherein the mixture comprises between about 67 and 72 weight percent DINCH plasticizer; 6 and 8 weight percent dioctyl adipate plasticizer; 12 and 17 weight percent homopolymer vinyl dispersion resin; 1 and 2 weight percent vinyl chloride homopolymer produced by the Pevikon process; 2 and 6 weight percent of epoxidized soybean oil; 0.8 and 5 weight percent heat stabilizer; and an amount of silicon which is sufficient to prevent the mixture from foaming.

14. A phthalate-free, pyrrolidone free liquid plastic fishing lure formulation, containing a DINCH plasticizer.

15. A phthalate-free liquid plastic formulation as in claim 14, further comprising:
a dioctyl adipate Plasticizer;
A monopolymer vinyl dispersion resin;
a vinyl chloride homopolymer produced by the Pevikon process capable of forming a paste;
an epoxidized soybean oil;
a heat stabilizer; and
a silicon.

16. A phthalate-free and pyrrolidone free liquid plastic fishing lure formulation as in claim 14, wherein the formulation includes between about:
5 and 90 weight percent DINCH plasticizer; further comprising between about 5 and 90 weight percent dioctyl adipate plasticizer;
10 and 50 weight percent homopolymer vinyl dispersion resin; 0.5 and 20 weight percent vinyl chloride homopolymer produced by the Pevikon process capable of forming a paste;
1 and 30 weight percent Epoxidized Soybean Oil;
0.5 and 10 weight percent Heat Stabilizer; and
a small amount of silicon sufficient to prevent foaming.

17. A phthalate-free and pyrrolidone free liquid plastic fishing lure formulation as in claim 14, wherein the formulation includes between about:
10 and 80 weight percent DINCH Plasticizer; further comprising between about:
0 and 70 weight percent dioctyl adipate Plasticizer;
10 and 20 weight percent homopolymer vinyl dispersion Resin;
0 and 10 weight percent vinyl chloride homopolymer produced by the Pevikon process;
0 and 10 weight percent epoxidized soybean oil;
1.5 to 10 weight percent heat stabilizer; and
an amount of silicon sufficient to prevent foaming.

18. A phthalate-free and pyrrolidone free liquid plastic fishing lure formulation, comprising between about:
67 and 72 weight percent DINCH Plasticizer;
6 and 8 weight percent dioctyl adipate Plasticizer;
12 and 17 weight percent homopolymer vinyl dispersion Resin;
1 and 2 weight percent vinyl chloride homopolymer produced by the Pevikon process;
2 and 6 weight percent epoxidized soybean oil;
0.8 and 5 weight percent heat stabilizer; and
an amount of silicon sufficient to prevent foaming.

19. A phthalate-free, liquid plastic fishing lure formulation comprising:
a Cyclohexane-1,2-dicarboxylate (DINCH) plasticizer.
a dioctyl adipate (DOA) Plasticizer;
A monopolymer vinyl dispersion resin;
a vinyl chloride homopolymer produced by the Pevikon process capable of forming a paste;
an epoxidized soybean oil;
a heat stabilizer; and
a silicon.

20. A phthalate-free liquid plastic fishing lure formulation as in claim 14, wherein the formulation is pyrrolidone free and the formulation includes between about:
5 and 90 weight percent DINCH plasticizer;
5 and 90 weight percent dioctyl adipate (DOA) plasticizer;
10 and 50 weight percent homopolymer vinyl dispersion resin;
0.5 and 20 weight percent vinyl chloride homopolymer produced by the Pevikon process;
1 and 30 weight percent Epoxidized Soybean Oil;
0.5 and 10 weight percent Heat Stabilizer; and
a small amount of silicon sufficient to prevent foaming.
